(19) United States
(12) Patent Application Publication
(10) Pub. No.: US 2005/0144605 A1
(43) Pub. Date: Jun. 30, 2005

(54) Information processing system and code generation method

(76) Inventors: Keiko Motokawa, Yokohama (JP); Shinichi Ito, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/975,437

(22) Filed: Oct. 29, 2004

(30) Foreign Application Priority Data
Dec. 26, 2003 (JP) 2003-432643

(51) Int. Cl. G06F 9/45

(52) U.S. Cl. 717/160

(57) ABSTRACT

In an information processing system, a strip-mining process for a plurality of loops can be efficiently executed exactly intended by a user.

A source program 206 includes strip-mining directives 401 and 402, which indicates a strip-mining applicable scope including two strip-mining target loops. A compiler converts the strip-mining applicable scope indicated by the strip-mining directives 401 and 402 into two inner loops and an outer loop surrounding the two inner loops, the inner loops being obtained by replacing each of the iterations of the two strip-mining target loops with a predetermined value and the outer loop having a number of steps corresponding to the predetermined value

### FIELD OF THE INVENTION

The present invention relates to a technique to increase efficiency in strip-mining process for a plurality of loops included in a source program.

### BACKGROUND OF THE INVENTION

In pages 350 to 352 of Michael Wolfe: High Performance Compilers for Parallel Computing, Addison Wesley Publishing Company, 1996 (hereinafter referred to as “non-patent document 1”), there is disclosed a strip-mining which converts a single loop to double loops. On the other hand, in Cray T3E Fortran Optimization Guide, Cray Research Inc., Document Number 004-2518-002, 1999, p.98 (hereinafter referred to as “non-patent document 2”), there is disclosed a technique that a plurality of loops are strip-mined by “256”. According to this strip-mining, step “256” outer loop is generated surrounding all the loops with “256” iterations, thereby increasing the potential for cache hits and suppressing an array size to be referred to.

However, it is to be noted that when a plurality of loops are included in a source program, even if a compiler executes the strip-mining based on a result of analysis as to the source program, the result is not always the one as intended by a user.

### SUMMARY OF THE INVENTION

An object of the present invention is to efficiently execute a strip-mining for a plurality of loops exactly as intended by a user, in an information processing system.

In order to solve the above problem, in the present invention, a first directive indicating a strip-mining applicable scope which includes an N-fold loop (N is a natural number) having a first strip-mining target loop and an M-fold loop (M is a natural number) having a second strip-mining target loop, is incorporated in a source program, and in an information processing system, as to the source program, the strip-mining applicable scope is converted into two inner loops and an outer loop surrounding the two inner loops, the inner loops being obtained by replacing iterations of the first and the second strip-mining target loops respectively within the N-fold and M-fold loops with a predetermined value, and the outer loop having the number of steps corresponding to the predetermined value.

According to the present invention, in the information processing system, it is possible to efficiently execute a strip-mining for a plurality of loops exactly as intended by the user.

### BRIEF DESCRIPTION OF THE DRAWINGS

FIG. 1 is a flowchart showing a strip-mining optimization processing relating to one embodiment of the present invention.

FIG. 2 is a diagram showing a configuration example of a computer system on which a compiler is implemented, relating to one embodiment of the present invention.

FIG. 3 is a flowchart showing a compiling process which is executed by a compiler relating to one embodiment of the present invention.

FIG. 4 is an illustration showing a descriptive example of a source program to be compiled by the compiler relating to one embodiment of the present invention and showing an image of an object program generated by compiling the source program.

FIG. 5 is a chart showing an example of an intermediate code generated by the source program as shown in (a) of FIG. 4.

FIG. 6 is an illustration conceptually showing a data structure of a loop table relating to one embodiment of the present invention.

FIG. 7 is an illustration conceptually showing a data structure of a strip-mining registration table relating to one embodiment of the present invention.

FIG. 8 is a flowchart showing a process executed in a strip-mining directive analysis process S102 of FIG. 1.

FIG. 9 is a flowchart showing a process executed in a strip-mining conversion process S103 of FIG. 1.

FIG. 10 is a chart showing an example of an intermediate code after the strip-mining conversion processing is executed.

FIG. 11 is an illustration showing a descriptive example of a source program including a strip-mining directive.

FIG. 12 is an illustration showing a descriptive example of a source program including a strip-mining directive.

FIG. 13 is an illustration showing an input example into a command line.

### DESCRIPTION OF THE PREFERRED EMBODIMENT

Referring to the attached drawings, preferred embodiments of the present invention will be explained.

At first, a source program as an object of compile processing relating to the present embodiment will be explained. Here, a source program described by FORTRAN language is given as an operative example.

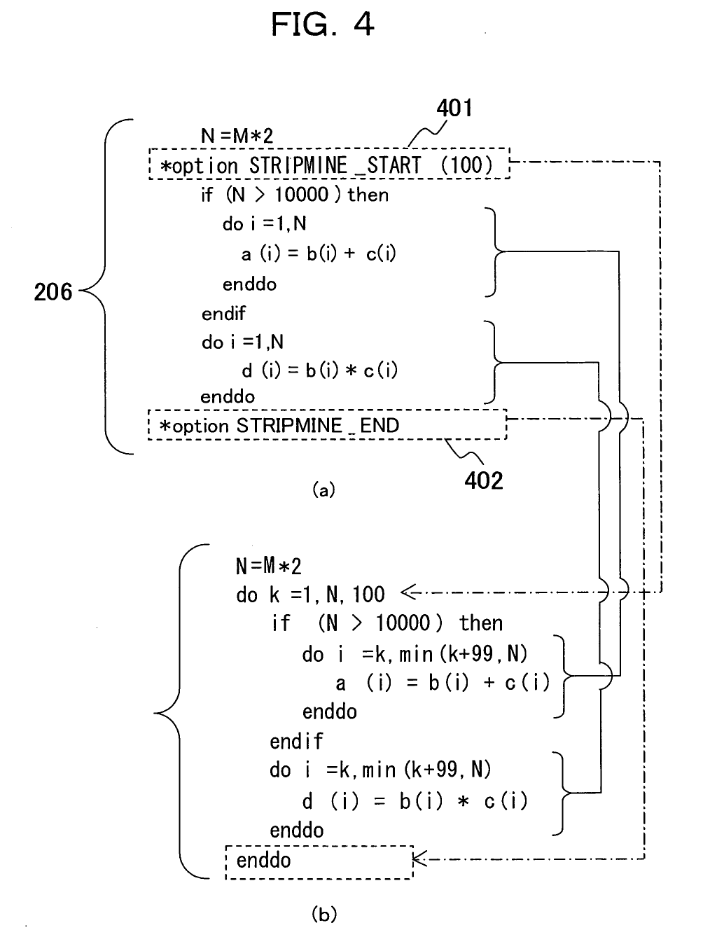

(a) of FIG. 4 shows a descriptive example of the source program 206. In this source program, a pair of strip-mining directives 401 and 402 is described to designate a strip-mining applicable scope.

Out of these strip-mining directives 401 and 402, the strip-mining directive 401 “*option STRIPMINE_START (100)” is to designate a start position of the strip-mining applicable scope, and it is inserted immediately before the strip-mining applicable scope. In here, the parameter value “100” designated in parentheses within the start directive indicates times of inner loops after strip-mining is executed (hereinafter, referred to as “block size”). This block size is defined so that a memory size, referred to in the inner loops after the stripmining, is to be equal to or less than cache size. Hereinafter, such a stripmining directive will be referred to as a start directive.

The other strip-mining directive 402 “*option STRIPMINE_END” is to designate an end position of the strip-mining applicable scope, and it is immediately after the strip-mining applicable scope. Hereinafter, such a strip-mining directive will be referred to as an end directive.

For the sake of simplicity in the following explanations, a program example in which a single pair of the start directive 401 and the end directive 402 is described here, but one or more pair of the start directive and the end directive can be contained in the source program as an object of compile processing relating to the present embodiment.

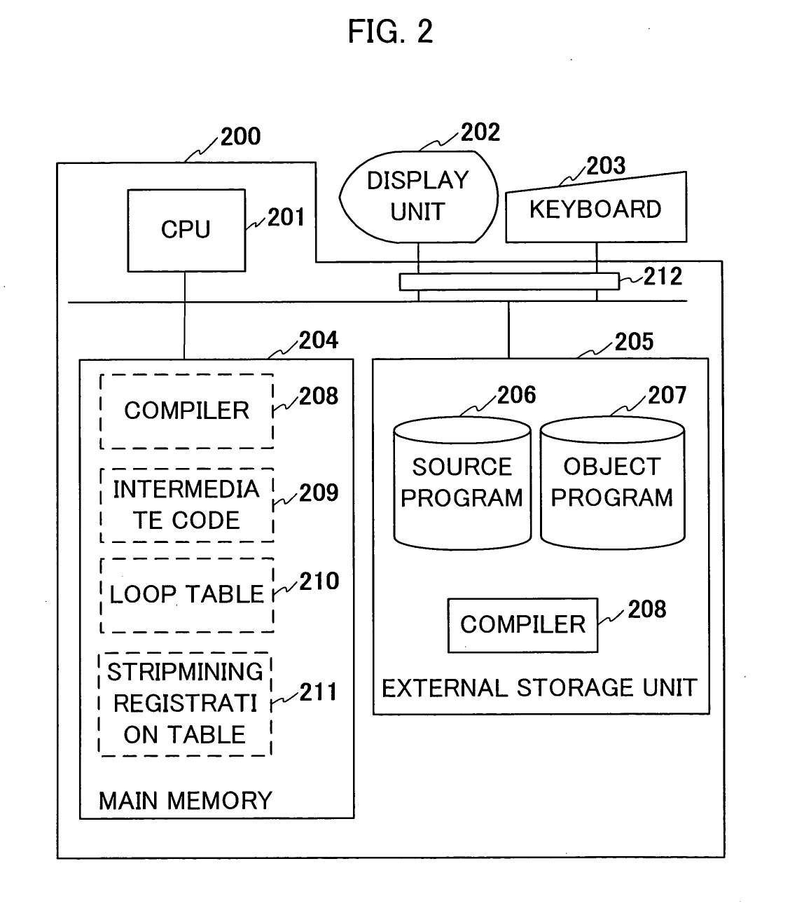

Next, with reference to FIG. 2, a configuration of the computer system which executes the compile processing relating to the present embodiment will be explained.

The computer system according to the present embodiment includes an information processing unit 200, an input unit 203 such as a keyboard, which provides the information processing unit 200 with a command (e.g., a compiler startup instruction including a source program name as an object of compile processing, and the like) inputted from a user, and a display unit 202 which displays output information (e.g., a compiler completion message, an error message, and the like) from the information processing unit 200.

The information processing unit 200 includes an external storage unit 205 in which a compiler 208 is installed, a main memory 204, CPU (Central Processing Unit) 201 which executes the compiler which has been loaded from the external storage unit 205 into the main memory 204, an I/O interface 212 to which the input unit 203 and the display unit 202 are connected, a drive (not illustrated) which controls data transfer with a storage medium such as an optical disc, a network interface, and the like.

The aforementioned source program 206 as an object of compile processing by the compiler 208 is constantly stored in the external storage unit 205. Then, while the compile processing is executed, data (intermediate code 209, loop table 210, strip-mining registration table 211), which is generated during the compile processing, is retained in the main memory 204. When the compile processing is completed, an object program 207 generated by the compile processing is stored in the external storage unit 205.

It is to be note that the compiler 208 may be the one installed into the external storage unit 205 from a storage medium, or may be the one installed into the external storage unit 205 by way of the network.

Next, a compile processing implemented by executing the compiler 208, in the computer system as shown in FIG. 2, will be explained.

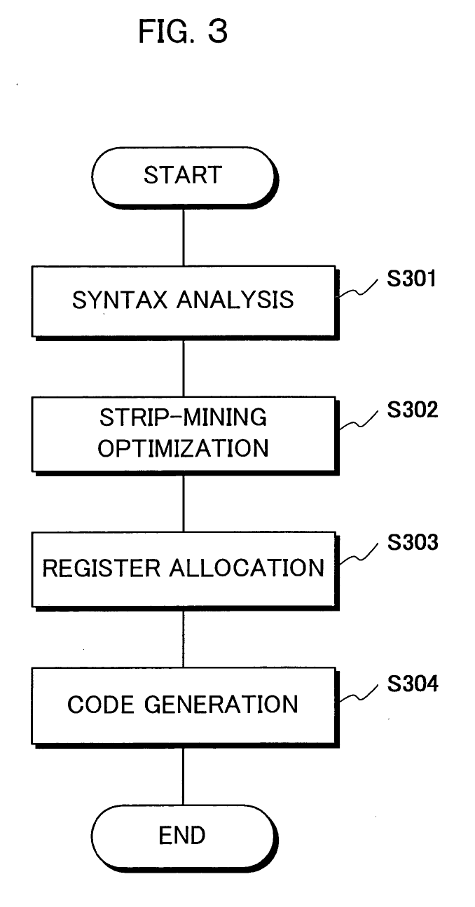

FIG. 3 is a flowchart showing the compile processing executed by the compiler 208.

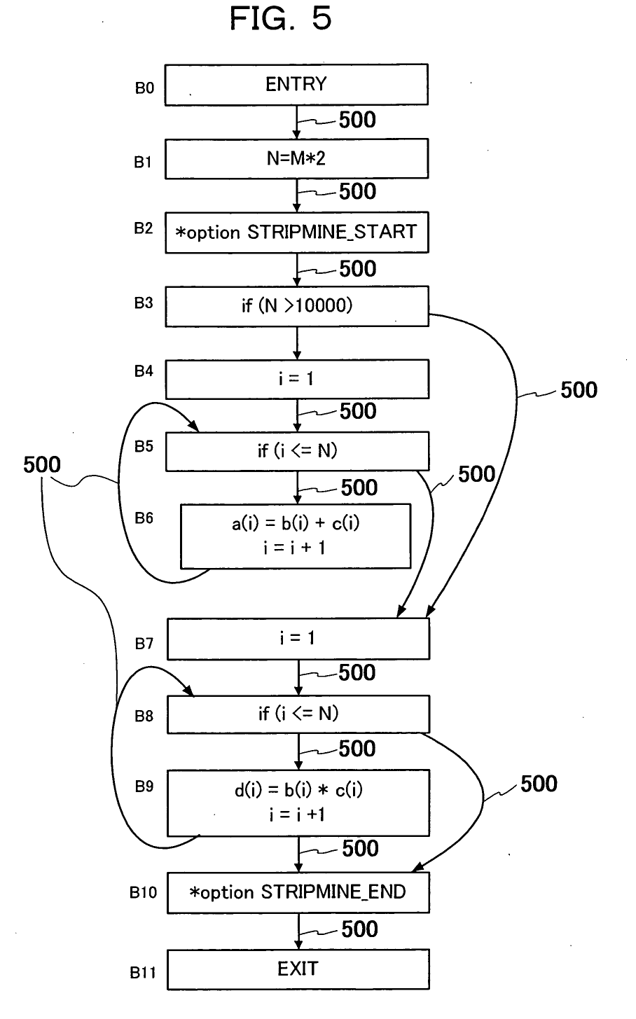

The compiler 208 being started, reads from the external storage unit 205, the source program 206 designated by the user, carries out a syntax analysis of the source program 206, and generates the intermediate code 209 based on a result of the analysis (S301). The intermediate code 209 thus generated is depicted as a control flow graph representing a control flow in the source program. The control flow graph generated from the source program 206 in (a) of FIG. 4 is shown in FIG. 5. This control flow graph shows basic blocks B0 to B11 (a series of code statements sequentially executed from the head without any branch or confluence), each being a node, and a transition path between the nodes is represented by edge 500. For ease of explanation as to the subsequent processing, any other code statement is not inserted in the basic block B2 including the start directive and the basic block B10 including the end directive.

Next, the compiler 208 sequentially executes a strip-mining optimization process (S302) to optimize the intermediate code 209, a register allocation process (S303) to allocate a register to each node of the intermediate code 209 thus optimized, a code generation process (S304) to convert the intermediate code 209 after the register allocation, into an object program 207.

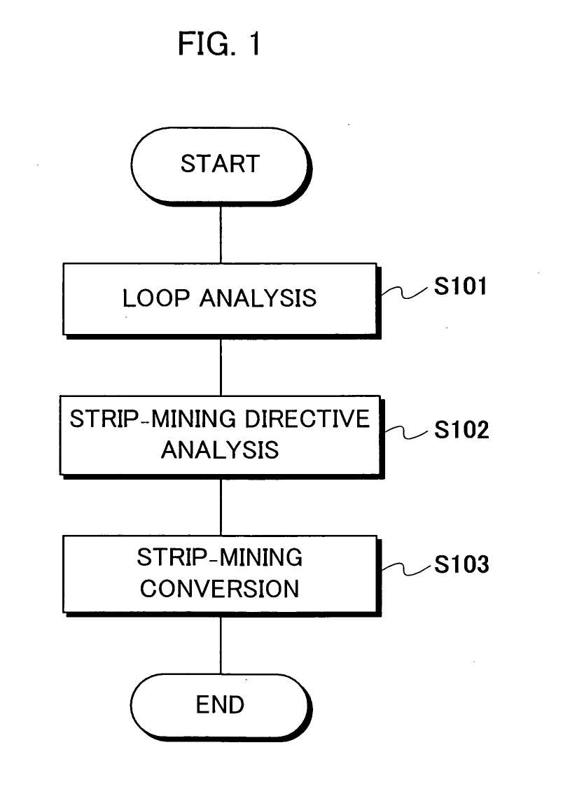

In the strip-mining optimization process S302 out of such series of processes above, the compiler 208 executes the processes S101 to S103 as shown in FIG. 1. Specifically, the compiler 208 executes, (1) a loop analysis process to obtain a group of loops included in the intermediate code 209 and records information related to each loop in the loop table 210 (S101), (2) a strip-mining directive analysis process to generate the strip-mining registration table 211 by analyzing the strip-mining directive (S102), and (3) a strip-mining conversion process on the basis of the strip-mining registration table 211 (S103). Hereinafter, details of each of the processes S101 to S103 will be explained.

(1) Loop Analysis Process (S101)

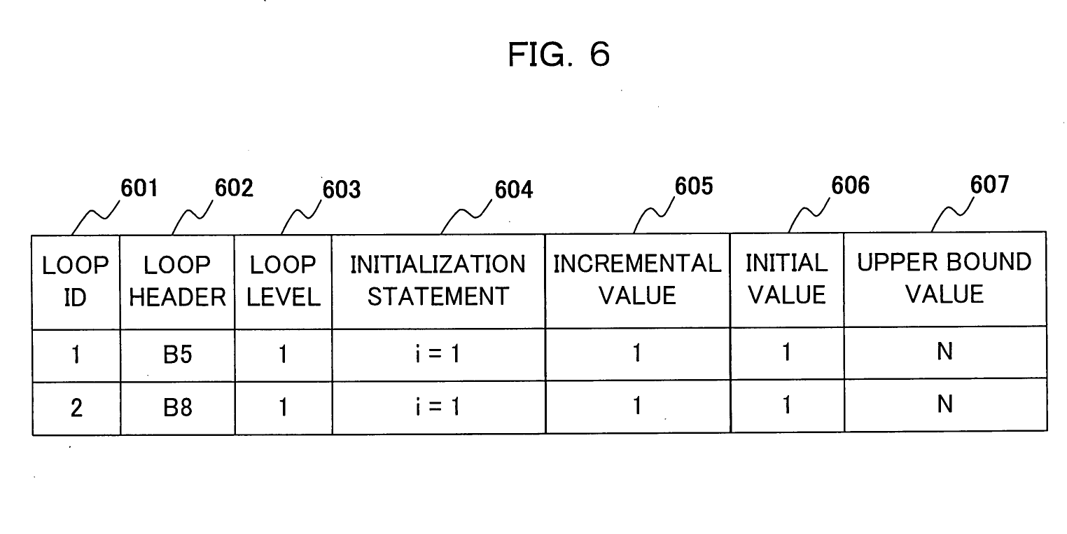

For example, the compiler 208 carries out loop analysis of the intermediate code 209 according to the loop analysis method as described in page 67 of the non-patent document 1, and registers a result of the analysis into the loop table 210. As an example of data structure of the loop table 210, the loop table obtained by analyzing the intermediate code of FIG. 5 is shown in FIG. 6. In this loop table, there are registered with respect to each of the two loops 1 and 2 included in the intermediate code as shown in FIG. 5, loop identification information 601, loop header information 602 which is identification information of the basic block as a loop entry point (hereinafter, referred to as loop header block), loop level information 603, which represents a loop level (information indicating the loop's ordinal position from the innermost loop; for example, if the loop is the innermost loop, the loop level is “1”, if the loop is the outer loop of double loops, the loop level is “2”), initialization statement 604 for a control variable of a loop (hereinafter, referred to as “the first loop control variable”), incremental value 605 of the first loop control variable, initial value 606 of the first loop control variable, and the upper bound value 607 of the first control variable.

(2) Strip-Mining Directive Analysis Process (S102)

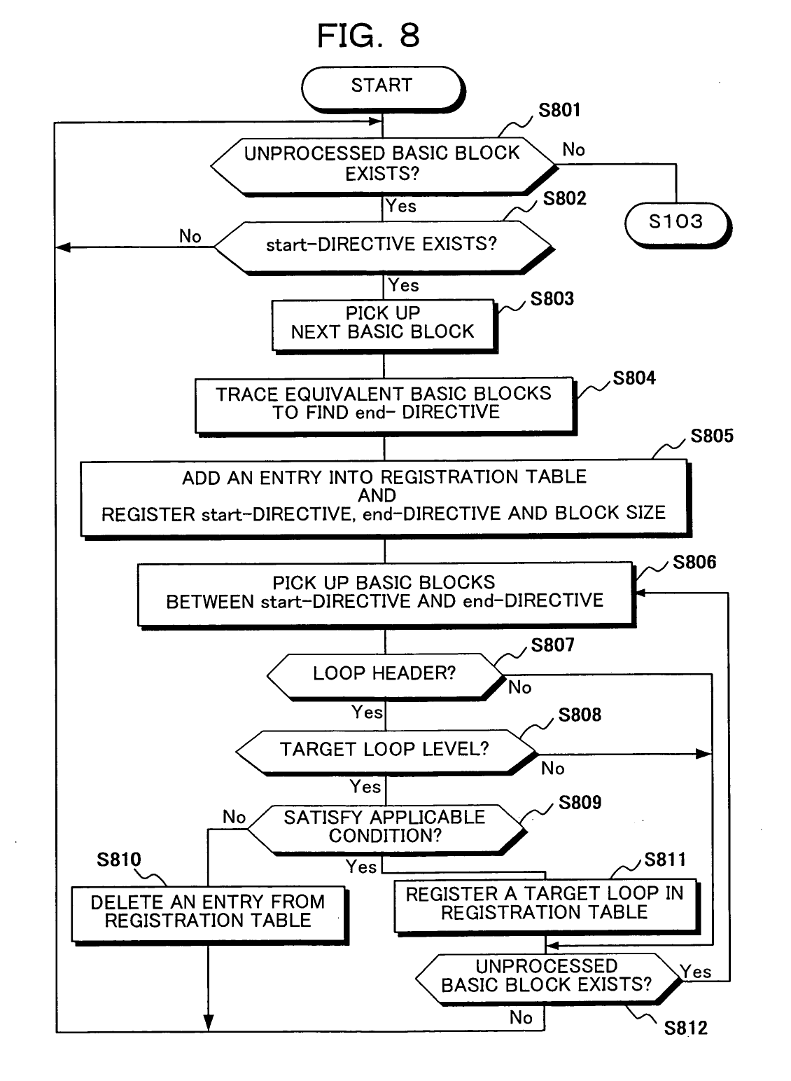

A flowchart for details of the strip-mining directive analysis process S102 is shown in FIG. 8. Here, it is assumed that the compiler 208 treats a basic block in the intermediate code 209 as a processing object basic block, sequentially from the headmost basic block.

The compiler 208 checks whether or not there remains in the intermediate code 209 a basic block which has not been processed yet (S801). If any unprocessed basic block does not exist in the intermediate code 209, strip-mining conversion process (S103) is executed. On the other hand, if there exists an unprocessed basic block in the intermediate code 209, the compiler 208 picks up as an processing object basic block, a basic block subsequent to the previous processing object block from the intermediate code 209 (S802), and checks whether or not this processing object basic block includes a start directive (S803).

As a result of checking, if the processing object basic block does not include a start directive, the compiler 208 executes the processes from S801 again.

On the other hand, if the processing object basic block includes the start directive, the compiler 208 traces sequentially toward the end, the subsequent basic blocks each equivalent to the processing object basic block, and searches for an end directive, which makes a pair with the start directive in the processing object basic block (S804). Here, a basic block B, which is equivalent to the processing object block A, is supposed to satisfy a condition that all the paths from the entry of the intermediate code to the basic block B pass through the processing object basic block A, and all the paths from the processing object basic block A to the intermediate code exit pass through the basic block B.

In the meantime, when an end directive which makes a pair with the start directive of the processing object basic block is obtained, the compiler 208 further executes the following processing.

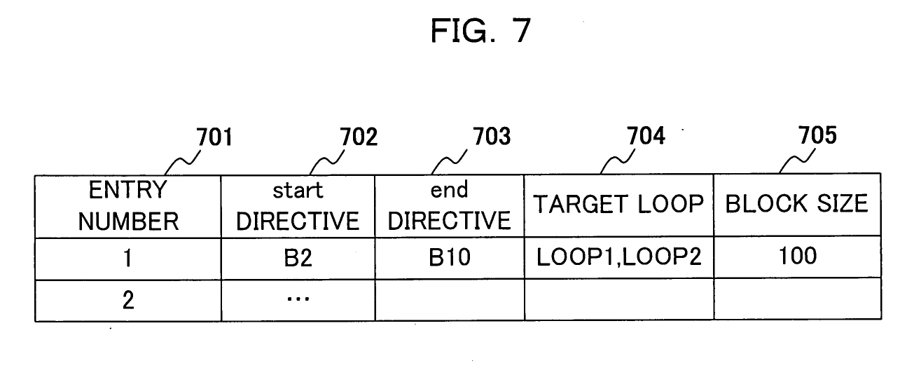

Firstly, the compiler 208 adds a new entry to the strip-mining registration table 211. At this timing, if any strip-mining table does not exist, the compiler 208 creates a strip-mining table. As shown in FIG. 7, the entries into the strip-mining table include a field 701 to register an entry number, a field 702 to register identification information of the basic block containing the start directive, a field 703 to register identification information of the basic block containing the end directive, a field 704 to register identification information of a loop included within the strip-mining applicable scope, and a field 705 to register a parameter value (block size) of the start directive.

Next, the compiler 208 registers a new entry number, identification information of the processing object basic block, identification information of the basic block containing the end directive obtained in S804, the parameter value (block size) of the start directive of the processing object basic block, respectively in the fields 701 to 703, and 705 of the new entry into the strip-mining table (S805).

Next, the compiler 208 extracts one basic block which is not targeted for checking whether or not it is a loop header block, out of the basic blocks between the processing object basic block and the basic block containing the end directive obtained in S804 (S806) and checks whether or not the identification information of thus extracted basic block is registered in the loop table 210 as loop header information, that is, whether or not the basic block is a loop header block (S807).

As a result, if the identification information of the basic block extracted in S806 is not registered in the loop table 210 as loop header information, the compiler 208 checks whether or not there exists a basic block, which is not targeted for checking if it is a loop header or not between the processing object basic block and the basic block containing the end directive obtained in S804 (S812). If such a basic block exists, the compiler 208 executes again the processing from S806 so as to check whether or not the basic block is a loop header block. To the contrary, if such a basic block does not exist, the compiler 208 executes again the processing from S801 so as to search for the next start directive.

On the other hand, if the identification information of the basic block extracted in S806 is registered in the loop table 210 as loop header information, the compiler 208 reads from the loop table 210 the loop level information associated with the loop header information, and checks whether or not the loop level information indicates a predetermined value as a loop level of the strip-mining target loop (hereinafter, referred to as “strip-mining target level”) (S808). For example, if the strip-mining target level is “1”, the compiler 208 checks in this step whether or not the loop level information read out from the loop table 210 is “1”.

If the loop level information read out from the loop table 210 does not indicate a strip-mining target level, that is, if the loop level of the loop whose header is a basic block extracted in S806 is not equal to the strip-mining target level, the compiler 208 executes the processing from S812 so as to check whether or not there exists a basic block which is not targeted for checking if it is a loop header block or not, between the processing object basic block and the basic block containing the end directive obtained in S804.

On the contrary, if the loop level information read out from the loop table 210 indicates the strip-mining target level, that is, the loop level of the loop whose header is the basic block extracted in S806 is equal to the strip-mining target level, the compiler 208 checks whether or not the loop satisfies another strip-mining applicable condition (S809). For example, if the strip-mining applicable condition is “incremental value of the first loop control variable=1”, the compiler 208 read out from the loop table 210, an incremental value associated with the identification information of the basic block extracted in S806, and checks whether or not the incremental value satisfies the condition of “incremental value of the first loop control variable=1”. Furthermore, if other conditions are defined as strip-mining applicable conditions, such as dependence test with another strip-mining target loop and agreement of initial value or upper bound value of the first loop control variable with those of another strip-mining target loop, it is also checked whether or not such conditions are satisfied.

As a result of the checking, if the loop whose header is the basic block extracted in S806 does not satisfy the strip-mining applicable condition, it is not possible to apply the strip-mining to the strip-mining applicable scope designated by the start directive and the end directive obtained in S803 and S804. Therefore, the compiler 208 deletes the entry newly added in S805 from the strip-mining registration table 211 (S810), and executes again the processing from S801 so as to search for the next start directive.

If the loop whose header is the basic block extracted in S806 satisfies the strip-mining applicable condition, the compiler 208 picks up from the loop table 210 loop identification information associated with the identification information of the basic block extracted in S806, registers the loop identification information in the field 704 of the entry added in the strip-mining registration table 211 in S805 (S811), and executes again the processing from S812.

In the strip-mining directive analysis process S102 as described above, the intermediate code of FIG. 5 is processed as follows. It is assumed here that the loop level of the strip-mining target loop is “1”, and the strip-mining applicable condition is “incremental value of the first loop control variable=1”.

Firstly, according to the iteration process from S801 to S803, the code statements within the basic block are sequentially checked from the basic block B0, and then, by checking the basic block B2, a start directive can be found. Secondly, the code statements within the basic blocks B3, B7, B10 each being equivalent to the basic block B2, are sequentially checked. Consequently, when the basic block B10 is checked, the end directive responding to the start directive of the basic block B2 can be found (S804) Thirdly, an entry is added into the strip-mining registration table 211, and a new entry number “1”, identification information of the basic block “B2” containing the start directive, identification information of the basic block “B10” containing the end directive, the parameter value (block size) “100” within the start directive are respectively registered in the fields 701 to 703, and 705 of the entry (S805).

Subsequently, according to the iteration process from S806 to S812, a loop whose header is the basic block B5 is firstly determined as a strip-mining target loop which satisfies the strip-mining applicable condition, out of the basic blocks B3 to B9 between the basic block B2 and B10. The identification information of this loop, “loop 1” is registered in the field 704 of the entry added in the strip-mining registration table 211. Next, a loop whose header is the basic block B8 is determined as a strip-mining target loop which satisfies the strip-mining applicable condition, and the identification information of this loop, “loop 2” is registered in the field 704 of the entry added in the strip-mining registration table 211.

Since only one pair of strip-mining directives is included in the intermediate code of FIG. 5, the strip-mining directive analysis process S102 is completed after the iteration process from S801 to S803 is executed, and then, the strip-mining conversion process (S103) is executed.

(3) Strip-Mining Conversion Process (S103)

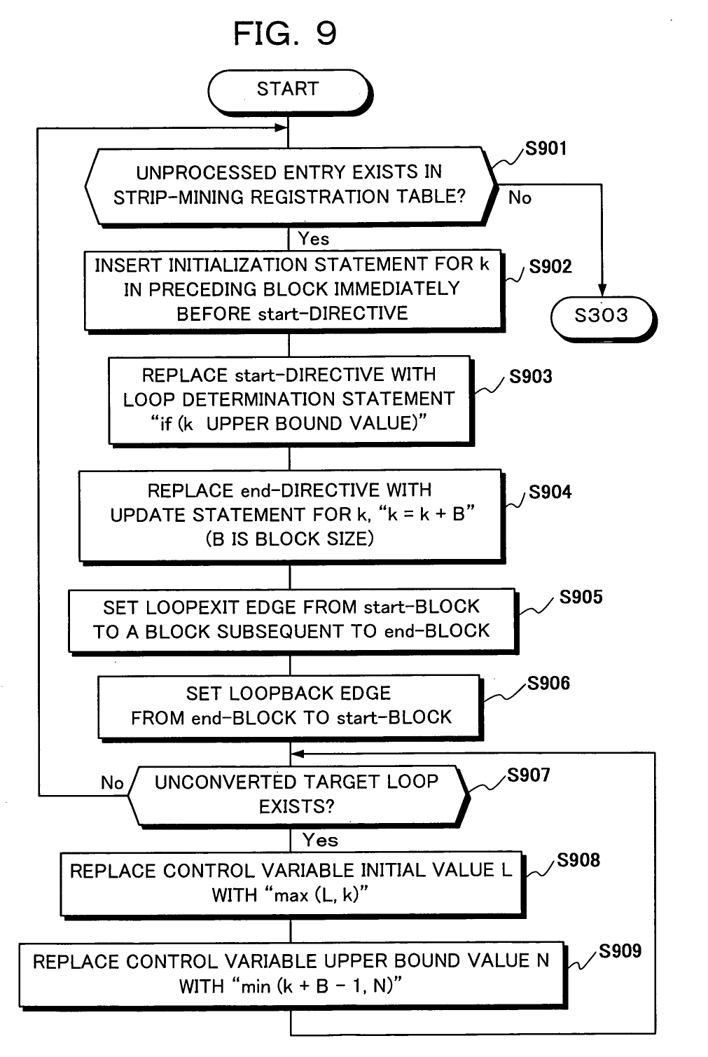

A flowchart of a detailed processing of the strip-mining conversion process S103 is shown in FIG. 9.

Here, it is assumed that the compiler 208 treats each entry within the strip-mining registration table 211 as a processing object entry, sequentially in the order of the entry number.

The compiler 208 checks whether or not there is an unprocessed entry in the strip-mining registration table 211, if there is not an unprocessed entry, the compiler 208 executes a register allocation process (S303).

On the other hand, if any unprocessed entry exists, the compiler 208 picks up an entry next to the previous processing object entry, as a processing object entry, from the strip-mining registration table 211 (S901). Subsequently, the compiler 208 picks up from the loop table 210, an initial value associated with the loop identification information registered in the field 704 of the processing object entry, and in order to assign the initial value as a loop control variable (hereinafter, referred to as “the second loop control variable k”), the compiler 208 generates an initialization statement “k=initial value” for the second loop control variable k. If there are registered multiple loop identification information items in the field 704 of the processing object entry, the compiler 208 picks up from the loop table 210 initial values respectively associated with the loop identification information items, and generates an initialization statement for the second loop control variable k, which assigns the minimum value in the initial values thus picked up. The compiler 208 inserts the initialization statement for the second loop control variable k into the preceding basic block, immediately before the basic block indicated by the block identification information registered in the filed 702 of the processing object entry (S902).

Furthermore, the compiler 208 picks up from the loop table 210, an upper bound value being associated with the loop identification information registered in the field 704 of the processing object entry, and generates a loop determination statement “if (k≦upper bound value)”, indicating a condition that the second loop control variable k is equal to or less than the upper bound value. If there are registered multiple loop identification information items in the field 704 of the processing object entry, the compiler 208 picks up from the loop table 210 upper bound values respectively associated with the loop identification information items, and generates a loop determination statement with a condition that the control variable k is equal to or less than the maximum value in those upper bound values thus picked up. The compiler 208 replaces the start directive within the basic block indicated by the loop identification information registered in the field 702 of the processing object entry, with thus generated loop determination statement (S903).

Next, the compiler 208 generates an update statement “k=k+B” for the second loop control variable k, which increments the second loop control variable k by a block size (assumed as “B”) registered in the field 705 of the processing object entry, and replaces the end directive within the basic block indicated by the identification information registered in the field 703 of the processing object entry, with thus generated update statement (S904).

Then, the compiler 208 sets a loop back edge from the basic block where the end directive has been replaced by the update statement of the control variable k to the block where the start directive has been replaced by the loop determination statement (S905). The compiler 208 further sets a loop exit edge from the basic block where the start directive has been replaced by the loop determination statement to a subsequent basic block immediately after the block where the end directive has been replaced by the update statement of the control variable k (S906).

According to the processing as described above, an intermediate code of the outer loop is generated, which surrounds the loops indicated by the loop identification information registered in the filed 704 of the processing object entry.

Afterwards, the compiler 208 converts the loops indicated by the loop identification information registered in the field 704 of the processing object entry one after another.

Specifically, the compiler 208 checks whether or not the conversion process have been executed for the loops indicated by all the loop identification information items registered in the field 704 of the processing object entry (S907). If no loops exist which have not been subjected to the conversion process yet, the compiler 208 executes again the processing from S901 so as to find the next processing object entry from the strip-mining registration table 211. If one or more loops exist which have not been subjected to the conversion process, the following processing is executed taking one of such loops as a conversion target.

The compiler 208 picks up from the loop table 210, an initialization statement of the first loop control variable as a conversion target, and searches for a basic block containing a statement corresponding to the initialization statement, out of the preceding basic blocks of the loop header block as a conversion target. The compiler 208 further replaces an initial value (assumed as “L”) within the initialization statement of the first loop control variable as a conversion target, which is included in the basic block obtained as a result of searching, with an output value of function “max (L, k) ” for returning the maximum value of argument (S908). The compiler 208 further replaces a loop control variable upper bound value (assumed as “N”) within the loop determination statement as a conversion target, which is included in the loop header block as a conversion target, with an output value of function “min (k+B −1, N)” for returning the minimum value of argument (S909). Then, the compiler 208 executes again the processing from S901 so as to find a next conversion target.

According to the strip-mining conversion processing S102 as described above, the intermediate code of FIG. 5 is processed as the following, based on the strip-mining registration table 211 and the loop table 210.

Firstly in S901 to S906, the intermediate code as shown in FIG. 5 is processed as follows.

An initialization statement “k=1” for the second loop control variable k is generated, which assigns to the second loop control variable k the minimum value “1” out of the control variable initial values “1”,“1” of the two loops (loop 1, loop 2), and this initialization statement “k=1” is inserted into the preceding basic block B1 immediately before the start directive block B2 (S901 to 902). Next, the start directive within the basic block B2 is replaced by the loop determination statement “if (k≦N)” with a condition that the maximum value “N” out of the upper bound values (“N”, “N”) of the first loop control variables of two loops (loop 1, loop 2) is the upper bound value of the second loop control variable k, and the end directive within the basic block B10 is replaced by the update statement “k=k+100” which increments the second loop control variable k by block size (S903 to S904). Furthermore, a loopback edge is set from the basic block B10 to the basic block B2, and an edge is set from the basic block B2 to the basic block B11 (S905 to S906).

Next, according to the iteration process from S907 to S909, the intermediate code is processed as follows.

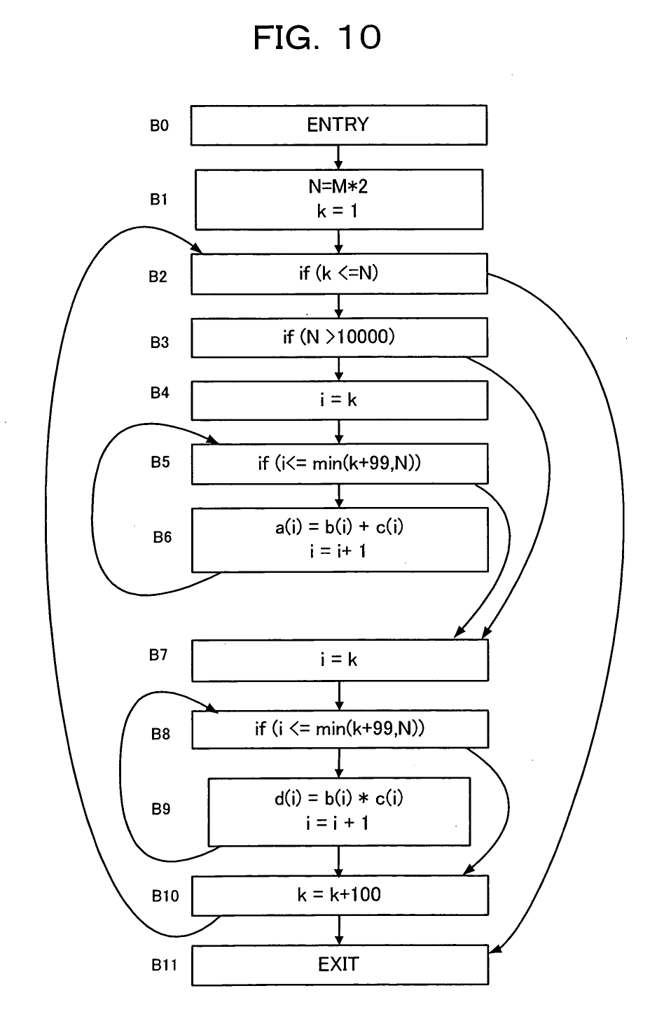

One loop (loop 1) out of the two loops (loop 1, loop 2) is targeted for conversion, and the initialization statement “i=1” and the loop determination statement “if (i≦N)” of the control variable for a conversion target are respectively replaced by “i=k” and “if (i<max (k+99, N)” (S908 to S909). Furthermore, the other loop (loop 2) is also targeted for conversion and similar processing is executed. The intermediate code thus converted is shown in FIG. 10, and a source image of this intermediate code is shown in (b) of FIG. 4.

As thus described, according to the strip-mining optimization process S302 relating to the present embodiment, the compiler carries out strip-mining as to a plurality of loops included in the strip-mining applicable scope indicated by the strip-mining directive inserted in the source program, with a block size designated by the strip-mining directive within the source program. Therefore, a user allows the compiler to execute the strip-mining processing efficiently as intended by the user, by inserting into a source program, a strip-mining directive indicating a strip-mining applicable scope including a plurality of loops to be targeted for strip-mining and a block size to be applied to the strip-mining.

In the case where a program tuning is carried out in order to find out an optimum block size, a block size is changed in accordance with an execution target machine, or the like, it is sufficient to modify only the strip-mining directive within the source program thereby reducing a work load for program modification by the user.

In the description above, a strip-mining optimization process is executed by use of a block size designated by a strip-mining directive and a predetermined strip-mining target level. However, the present invention is not necessarily limited to this configuration.

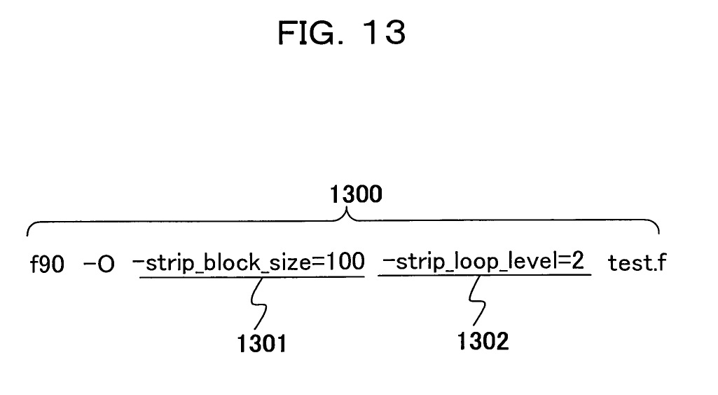

For example, as shown in FIG. 13, it may be possible to designate a strip-mining target level and a block size with an option as indicated in a command 1300 for starting up the compiler. In FIG. 13, with the -O option subsequent to the startup command of the compiler, the block size “100” 1301 and the strip-mining target level “2” 1302 are designated. When such a startup command is used, the compiler 208 is required to execute the above explained strip-mining optimization process by use of the block size and the strip-mining target level which have been designated with the option.

FIG. 13 shows an example for inputting a command line when both the block size and the strip-mining target level are designated by the command option. However, it is also possible to designate either one of the block size and the strip-mining target level with the command option. For example, when a designation of the block size is included in the strip-mining directive and only the strip-mining target level is designated with the command option, the compiler 208 may just execute the above strip-mining optimization process by use of the block size designated in the strip-mining directive and the strip-mining target level designated by the command option. On the other hand, when a strip-mining target level is predetermined and only the block size is designated by a command option, the compiler 208 may just execute the above strip-mining optimization process by use of the predetermined strip-mining target level and the block size designated by the command option.

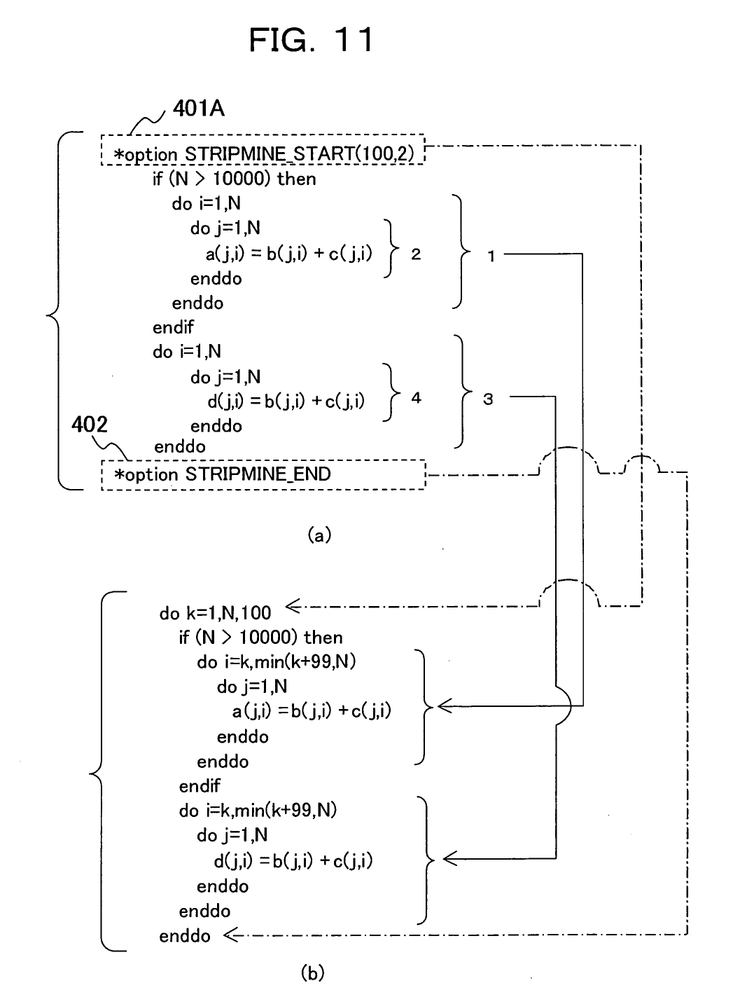

It may be also possible to designate both the block size and the strip-mining target level by the start directive. (a) of FIG. 11 shows an example of source program in which a start directive including the block size and the strip-mining target level as arguments.

This source program includes two double loops. There is described a start directive 401A having the block size “100” and the strip-mining target level “2” respectively as the first argument and the second argument. When the source program with a description of this start directive is designated as a compile object, the compiler 208 is required to execute the above strip-mining optimization process by use of the block size “100” and the strip-mining target level “2” respectively designated by the first argument and the second argument of the start directive 401A. For example, when the source program as shown in (a) of FIG. 11 is compiled, the outer loops 1, 3 (loop level “2”) of the two double loops are subjected to the strip-mining with the block size “100”. Consequently, the intermediate code represented by the source image as shown in (b) of FIG. 11 is generated.

FIG. 11 shows an example of the source program in which a start directive having the block size and the strip-mining target level as arguments is described. However, it is also possible to configure such that only the strip-mining target level is given to the start directive as an argument and the block size is designated by a command option.

In the above explanation, the compiler 208 extracts a strip-mining target loop based on a loop level of the loop header block, but it is not necessary to configure in this manner. For example, as explained in the following, it may also possible to describe in the source program a directive which designates a strip-mining target loop.

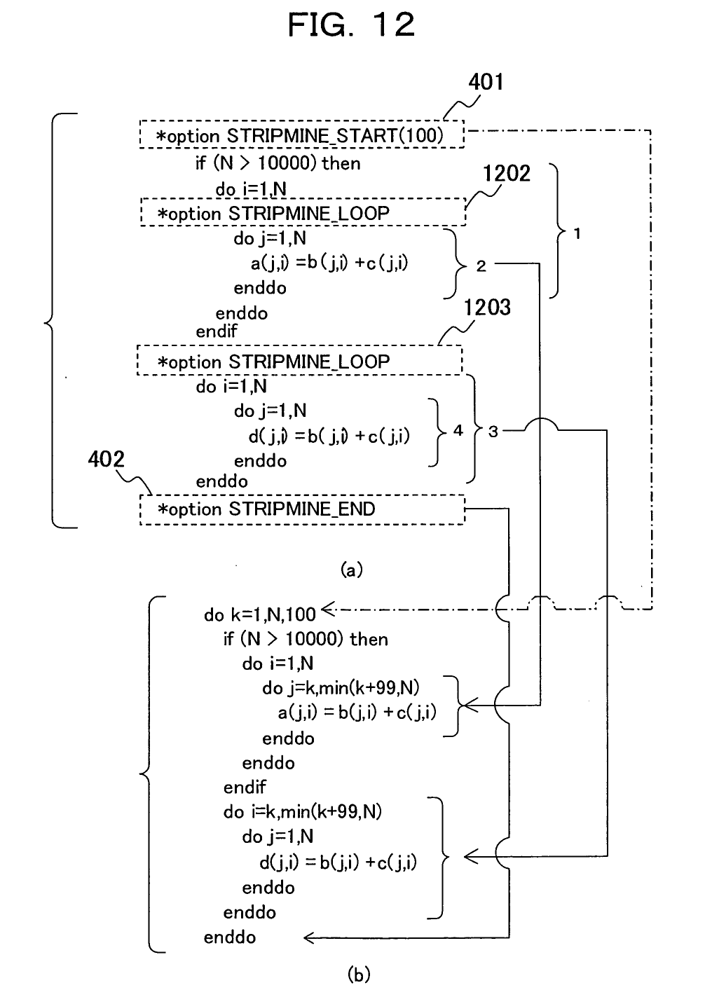

(a) of FIG. 12 shows an example describing such a source program as described above. This source program includes two double loops. Furthermore, there are described directives “*option STRIPMINE_LOOP” 1202 and 1203 designating strip-mining target loops. These directives 1202 and 1203 are described immediately before the loops 2 and 3, respectively, which are to be strip-mining target loops out of the loops included in each of the double loops. When this type of source program is targeted for compiling, the compiler 208 determines whether or not the directive “*option STRIPMINE_LOOP” is included in the preceding basic block, placed immediately before the loop header block in S809, instead of determining whether or not the loop level of the loop header block is equal to a strip-mining target level, whereby the compiler 208 is required to extract a loop header block as a strip-mining target loop. For example, when the source program as shown in (a) of FIG. 12 is compiled, the inner loop 2 (loop level is “1”) of one double loop and the outer loop 3 (loop level “2”) of the other double loop are subjected to the strip-mining with the block size of “100”. Consequently, the intermediate code represented by the source image as shown in (b) of FIG. 12 is generated.

It is also possible to use the designation of strip-mining target loop by the directive “*option STRIPMINE_LOOP”, in combination with the determination of strip-mining target loop by use of the strip-mining target level. Specifically, if the directive “*option STRIPMINE_LOOP” is included in the strip-mining applicable scope, the strip-mining optimization process S302 may be executed using the loop designated by the directive as a strip-mining target loop. On the other hand, if the directive “*option STRIPMINE_LOOP” is not included in the strip-mining applicable scope, the strip-mining optimization process S302 may be executed using the loop having the strip-mining target level as a strip-mining target loop.

Examples of the present invention applied to a compiler have been explained so far, but the present invention is also applicable to other program (for example, a translator), which executes a process to optimize a loop.

1. An information processing system, comprising:
an input accept means which accepts an input of identification information of a source program including a first directive indicating a strip-mining applicable scope which contains N-fold loop (N is a natural number) having a first strip-mining target loop, and an M-fold loop (M is a natural number) having a second strip-mining target loop, and
a compute processing means which converts, as to the source program corresponding to said identification information accepted by said input accept means, said strip-mining applicable scope indicated by said first directive into two inner loops and an outer loop surrounding the two inner loops, the inner loops being obtained by replacing iterations of said first strip-mining target loop and said second strip-mining target loop with a predetermined value, respectively within said N-fold loop and said M-fold loop, and the outer loop having number of steps corresponding to said predetermined value.

2. The information processing system according to claim 1, wherein,
said input accept means accepts as input information, at least either of said predetermined value and information for defining loops which are to be said first strip-mining target loop and second strip-mining target loop, and
said compute processing means executes a conversion of said strip-mining applicable scope by use of said input information which is accepted by said input accept means.

3. The information processing system according to claim 1, wherein
said first directive includes as designation information, at least either of said predetermined value and information indicating loops which are to be said first strip-mining target loop and said second strip-mining target loop, and
said compute processing means executes a conversion of said strip-mining applicable scope by use of said designation information included in said first directive.

4. The information processing system according to claim 1, including a second directive which designates loops respectively to be said first strip-mining target loop and said second strip-mining target loop, wherein,
said compute processing means replaces iterations of the first strip-mining target loop and the second strip-mining target loop designated by said second directive, with a predetermined value.

5. A program which is executed by an information processing unit having an input accept means and a compute processing means, comprising the steps of:
an input accept process in which said input accept means accepts an input of identification information of a source program including a first directive indicating a strip-mining applicable scope which contains N-fold loop (N is a natural number) having a first strip-mining target loop, and an M-fold loop (M is a natural number) having a second strip-mining target loop, and
a loop conversion process in which said compute processing means converts, as to the source program corresponding to said identification information accepted by said input accept means, said strip-mining applicable scope indicated by said first directive into two inner loops and an outer loop surrounding the two inner loops, the inner loops being obtained by replacing iterations of said first strip-mining target loop and said second strip-mining target loop with a predetermined value, respectively within said N-fold loop and said M-fold loop, and the outer loop having number of steps corresponding to said predetermined value.

6. The program according to claim 5, wherein,
in said input accept process, said input accept means accepts as input information, at least either of said predetermined value and information for defining loops which are to be said first strip-mining target loop and second strip-mining target loop respectively within said N-fold loop and said M-fold loop, and
in said loop conversion process, said compute processing means executes a conversion of said strip-mining applicable scope by use of said input information which is accepted by said input accept means.

7. The program according to claim 5, wherein
said first directive includes as designation information, at least either of said predetermined value and information for defining loops which are to be said first strip-mining target loop and said second strip-mining target loop respectively within said N-fold loop and said M-fold loop, and
in said loop conversion process, said compute processing means executes a conversion of said strip-mining applicable scope by use of said designation information included in said first directive.

8. The program according to claim 5, wherein,
said source program includes a second directive which designates said first strip-mining target loop and said second strip-mining target loop respectively in said N-fold and M-fold loops, and
in said loop conversion process, said compute processing means replaces each of iterations of the first strip-mining target loop and the second strip-mining target loop indicated by said second directive, with a predetermine value.

9. A machine-readable recording medium in which the program according to claim 5 is recorded.

10. A code generation method which allows an information processing unit having an input accept means and a compute processing means to execute a loop conversion process, comprising the steps of:
an input accept process in which said input accept means accepts an input of identification information of a source program including a first directive indicating a strip-mining applicable scope which contains N-fold loop (N is a natural number) having a first strip-mining target loop, and an M-fold loop (M is a natural number) having a second strip-mining target loop, and
a loop conversion process in which said compute processing means converts, as to the source program corresponding to said identification information accepted by said input accept means, said strip-mining applicable scope indicated by said first directive into two inner loops and an outer loop surrounding the two inner loops, the inner loops being obtained by replacing iterations of said first strip-mining target loop and said second strip-mining target loop with a predetermined value, respectively within said N-fold loop and said M-fold loop, and the outer loop having number of steps corresponding to said predetermined value.
